(19) United States
(12) Patent Application Publication
(10) Pub. No.: US 2025/0294062 A1
(43) Pub. Date: Sep. 18, 2025

(54) WEB BASED ELECTRONIC DEVICE REGISTRATION

(71) Applicant: Lenovo (Singapore) Pte. Ltd., Singapore (SG)

(72) Inventors: Xueshi Wang, Cary, NC (US); Andrew Hansen, Raleigh, NC (US); Hassan Mahini, Cary, NC (US); Sriram Thota, Tracy, CA (US); Vishal Kontham Ramdass, Celina, TX (US)

(21) Appl. No.: 18/603,142

(22) Filed: Mar. 12, 2024

(51) Int. Cl. H04L 65/1073; H04W 60/00

(52) U.S. Cl. CPC H04L 65/1073; H04W 60/00

(57) ABSTRACT

A method of registering a device with a remote management system includes establishing a communication connection between an electronic device to a computer. The computer is then connected via a web browser to the remote management system. The electronic device is detected, and a user interface is provided via the computer to display an identification of the electronic device. A registration request for the electronic device is then received via the user interface and the electronic device is registered with the remote management system.

### BACKGROUND

To enroll Android OS-based devices with device management software, the device needs to have a provisioning file that can be accessed by a device management client. Usually the fastest way to obtain the provisioning file is to scan a QR code using the device's camera. However, many Android devices lack the ability to scan the QR code, which causes enrollment to become cumbersome work.

Other existing solutions require the user to download the provisioning file from a device management software portal to a computer such as a personal computer (PC). Following downloading of the provisioning file to the PC, the device will often need to be plugged into the PC and then either 1) drivers and additional software are installed followed by a command line interface used to push a provisioning file, or 2) Media Transfer Protocol (MTP), a standard for connecting media devices and smartphones over USB, allows for the transfer of media files and metadata to and from devices and an MTP mode can be enabled on the device to allow file transfers. Either way, the user must know the specific location for the provisioning file to be placed on the device in order for the device management client application to find file and utilize it.

Many users are not comfortable with command line interfaces, and often it is the case that IT (Information Technology) department security rules prevent users from installing software/drivers on their corporate machines. The user must also know the exact location of where to push the provisioning file to the device, which may be different depending on the various device management providers and finding the correct locations to push to the devices can be time-consuming. Still further, the name of a stored provisioning file may need to be exact. Rebooting of devices may also be required, which can take significant time that adds up when registering multiple devices, such as hundreds or thousands of devices.

### SUMMARY

A method of registering a device with a remote management system includes establishing a communication connection between an electronic device to a computer. The computer is then connected via a web browser to the remote management system. The electronic device is detected, and a user interface is provided via the computer to display an identification of the electronic device. A registration request for the electronic device is then received via the user interface and the electronic device is registered with the remote management system.

### BRIEF DESCRIPTION OF THE DRAWINGS

FIG. 1 is a block diagram of a system for registering electronic devices according to an example embodiment.

FIG. 2 is a block flow diagram illustrating a method for registering electronic devices according to an example embodiment.

FIG. 3A is a screen shot of a user interface for adding connected devices according to an example embodiment.

FIG. 3B is a screen shot of a user interface for connecting a device according to an example embodiment.

FIG. 3C is a screen shot of a user interface for registering a connected device according to an example embodiment.

FIG. 3D is a screen shot of a user interface showing a status of a device to be registered according to an example embodiment.

FIG. 3E is a screen shot of a user interface showing a status of a registered device for according to an example embodiment.

FIG. 3F is a screen shot of a user interface showing details of a registered connected device according to an example embodiment.

FIG. 4 is a flowchart illustrating a method of registering a device according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

An improved device management system enables device registration for remote management directly from a web browser, with no need for additional software to be installed or for the user to have domain-specific knowledge. This removes the pain points related to installing and using the ADB (Android Debug Bridge) CLI (command line interface) and works for all Android OS-based devices even if they lack the capability of scanning QR codes.

Because the system facilitates browser-based registration, it is further possible for a great deal of UI (user interface) customizations to be implemented that will enable variations specific to the device manager's and the end user's needs and preferences. The result is a highly customizable experience that can range from simple and streamlined (one-button registration) to any degree of complexity needed.

In one example, the system uses WebUSB (Web universal serial bus) protocols available in all modern Chromium-based browsers as well as a WebADB library. WebUSB is a JavaScript API (Application Programming Interface) specification that allows web applications to securely access USB devices. WebADB is based on WebUSB and is a free, open-source web service that allows users to debug Android devices from any supported browser. It is a WebUSB-based library and API for managing and manipulating connected Android devices.

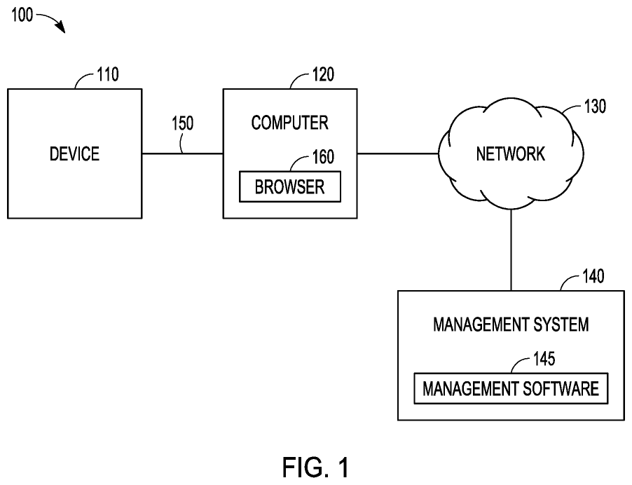

FIG. 1 is a block diagram of a system 100 for registering an electronic device 110 according to an example embodiment. System 100 includes a computer 120, such as a personal computer coupled to a network 130. A management system 140 is coupled to the network 130 and includes management software 145 for managing devices. Management software 145 may include the ability to provision connected devices, such as electronic device 110 to ensure such devices have up to date software, virus protection, authorizations, sufficient memory and storage, and are otherwise configured correctly and even operating correctly.

In one example, device 110 is coupled to computer 120 via connection 150. In various examples, connection 150 may include a wireless connection and may also represent a wired connection, such as by a USB cable. Computer 120 may include a browser 160 for communicating with management system 140 and management software 145. A user of computer 120 may provide credentials to connect to the management system 140 and management software 145 in order to provide a portal user interface for use in connecting to and registering device 110.

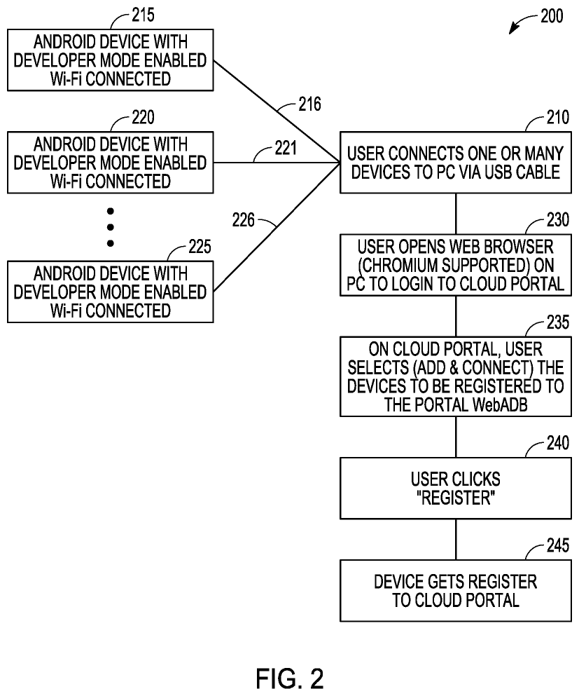

FIG. 2 is a block flow diagram illustrating a system and method generally at 200 for registering electronic devices according to an example embodiment. One or more electronic devices may be registered. A computer 210 may be used to connect multiple devices 215, 220, and 225 via respective connectors 216, 221, and 226. In one example, the computer 210 may be a personal computer, and the connectors may be USB cables. The devices 215, 220, and 225 may be android devices with developer mode enabled and Wi-Fi connected with computer 210.

Following connection of the devices, a user of the computer 210 may open a web browser at operation 230, such as a Chrome® browser to log into a cloud portal, such as management system 140 and management software 145 shown in FIG. 1. The cloud portal provides a portal interface for display on the computer 210 via the browser 160.

At operation 235, the user may interact with the cloud portal to add connected devices 215, 220, and 225 for registration to the portal via the network 130, also referred as the web. WebADB may be used for such registration in one example, or any other type of connection that permits data transfer suitable for performing registration of devices once a user selects or clicks “register” at operation 240 via the portal interface. At operation 245, the device becomes registered to the cloud portal, enabling management functions to be performed on the device, including obtain status of each registered device and provisioning of each registered device. In various examples, the devices may be registered serially or in parallel provided the computer 210 includes multiple ports, as one port is used to register each device.

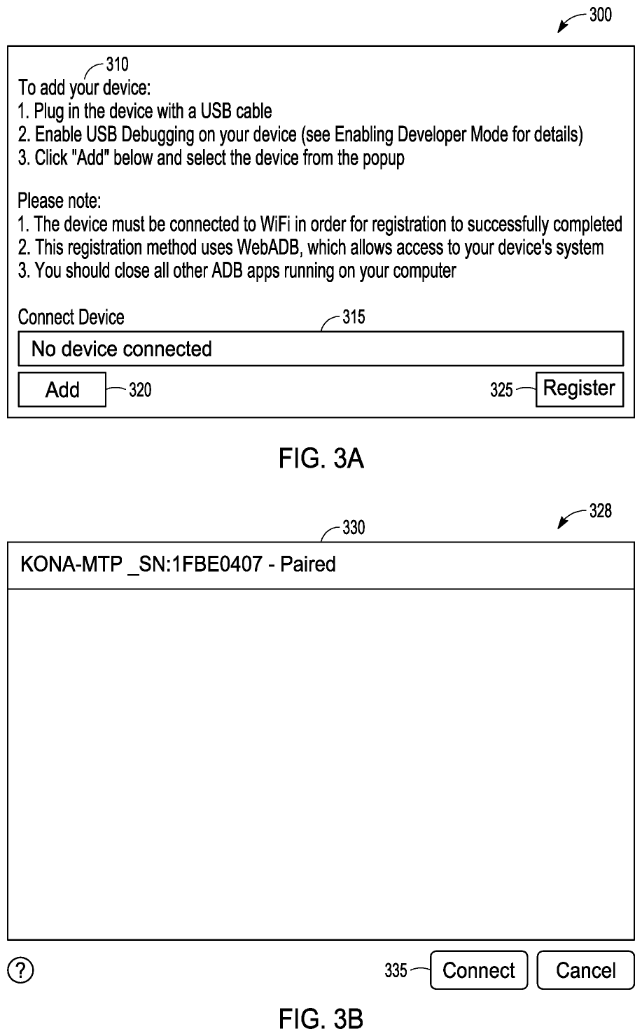

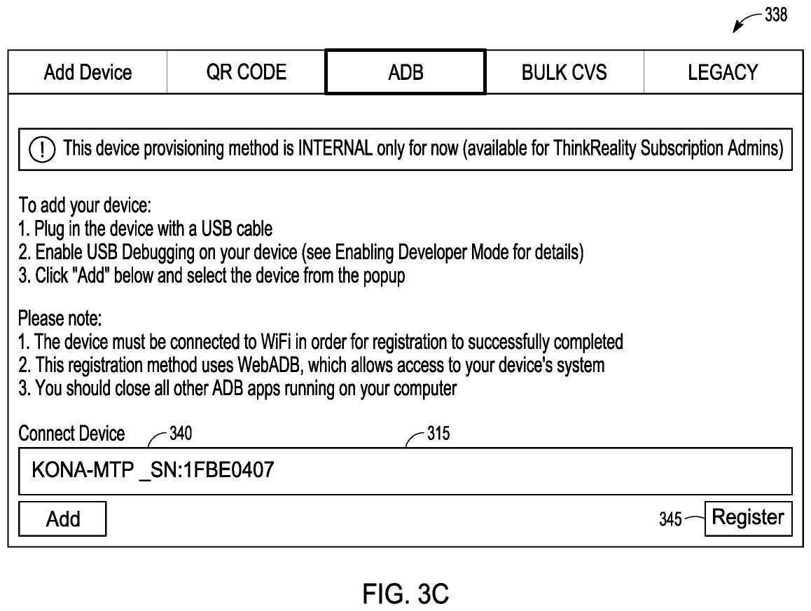

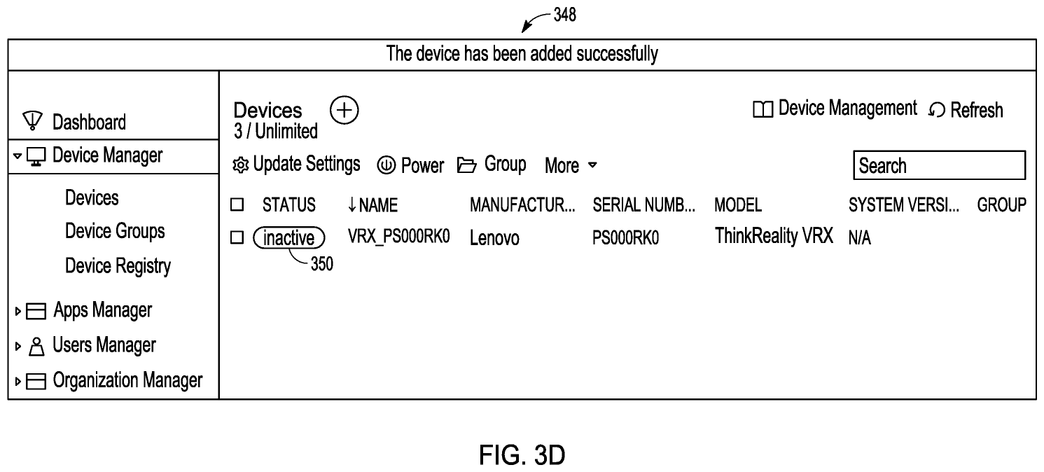

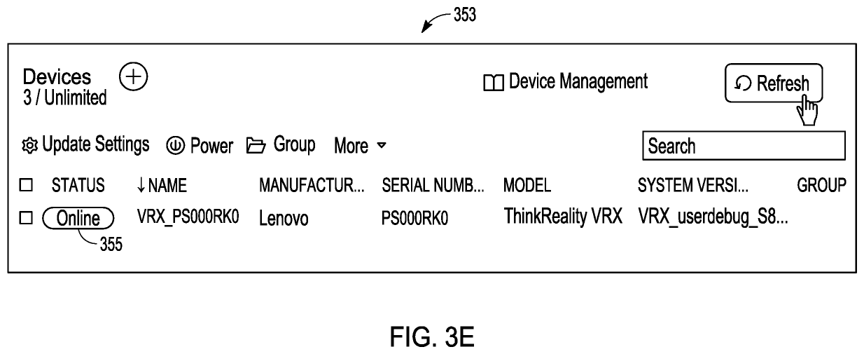

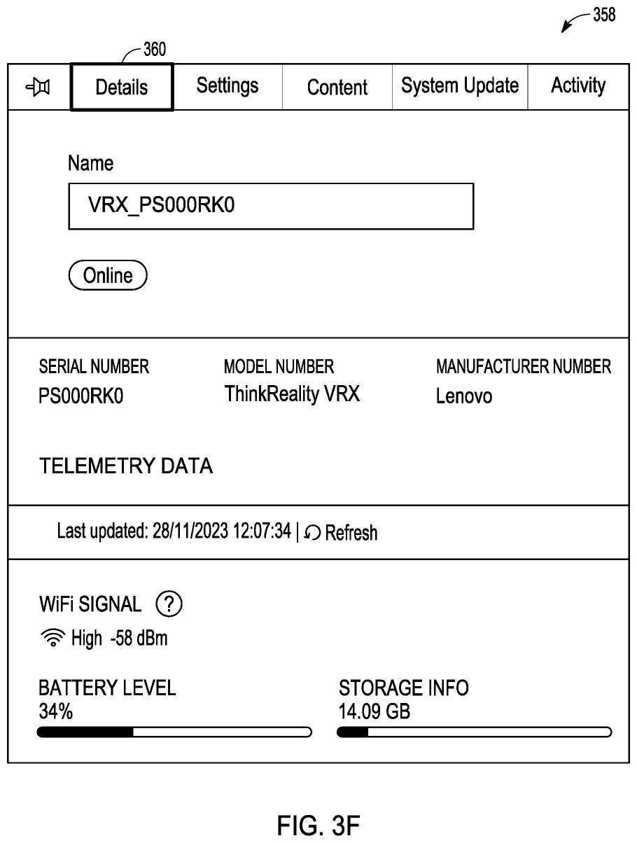

FIG. 3A is a screen shot of a user interface 300 for adding connected devices according to an example embodiment. In one example, user interface 300 includes instructions 310 to add a device to a list 315 of connected devices that is displayed. Instructions 310 may direct a user to plug the device into the computer 210, enable USB debugging on the device with a link to further instructions on how to do so, and to click Add 320. The instructions 310 may also provide notes for the user to ensure success in adding a device. The notes direct the user to make sure the device is connected to a network via cable or a wireless connection such as WiFi. The notes may also include a warning that enabling WebADB allows access to the device's system and that all other ADB apps running on computer 210 should be closed to ensure successful completion of registration.

User interface 300 also includes a register 325 selection which is not currently shown as available since no devices are currently connected.

FIG. 3B is a screen shot of a user interface 328 for connecting a device according to an example embodiment. Interface 328 results from selecting Add 320 and includes a statement 330 that a device having the name of KONA-MTP_SN:1FBE0407 is Paired. A connect button 335 when selected connects the paired device.

FIG. 3C is a screen shot of a user interface 338 for registering a connected device according to an example embodiment. User interface 338 includes list 315 that now includes the KONA-MTP_SN:1FBE0407 shown as connected at 340. A register button 345 is now enabled and available for selection.

FIG. 3D is a screen shot of a user interface 348 showing a status of a device in the process of being registered following selection of the register button 345 according to an example embodiment. Interface 348 includes a status 350 of Inactive.

FIG. 3E is a screen shot of a user interface 353 showing a status of a registered device as Online at 355 for according to an example embodiment.

FIG. 3F is a screen shot of a user interface 358 showing details 360 of a registered connected device according to an example embodiment.

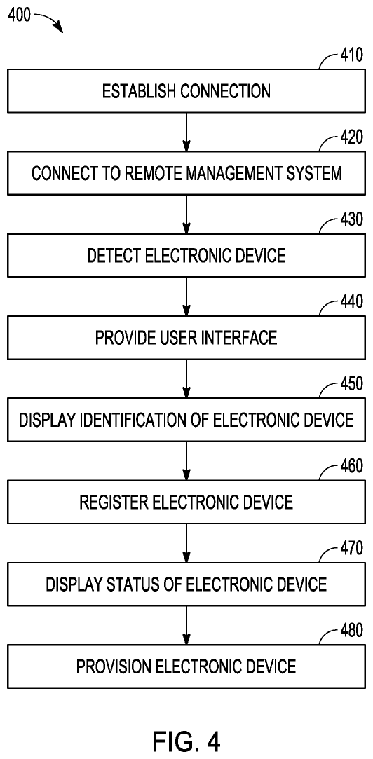

FIG. 4 is a flowchart illustrating a method 400 of registering a device according to an example embodiment. Method 400 begins at operation 410 by establishing a communication connection between an electronic device to a computer. The communication connection in one example is a universal serial bus (USB) cable. WiFi or other wireless or wired method of connecting to a network is also enabled on the electronic device and computer.

Operation 420 connects the computer via a web browser to a remote management system. USB debugging may also be enabled to provide a communication protocol for data transfer between the management system and the device. The electronic device may be accessed via WebADB (Web Android® Debugging Bridge). The electronic device is detected at operation 430, such as via the cable. Connection information in the electronic device may be accessed and transferred to the remote management device. The connection information comprises security information to authorize registration of the electronic device.

A user interface is provided via the computer at operation 440 by displaying an identification of the electronic device. A registration request is received at operation 450 for the electronic device via the user interface. The electronic device and computer are connected via a wired or wireless connection such as WiFi to complete registration with the remote management system.

In one example, the user interface comprises a remote management system portal. The devices is registered with the remote management system responsive to the registration request at operation 460. Operation 470 displays a status of the electronic device via the user interface once registered and connected. The status of “online” means the device has been successfully registered and is available for provisioning and management.

In one example, the device is provisioned at operation 480 via the remote management system following registration.

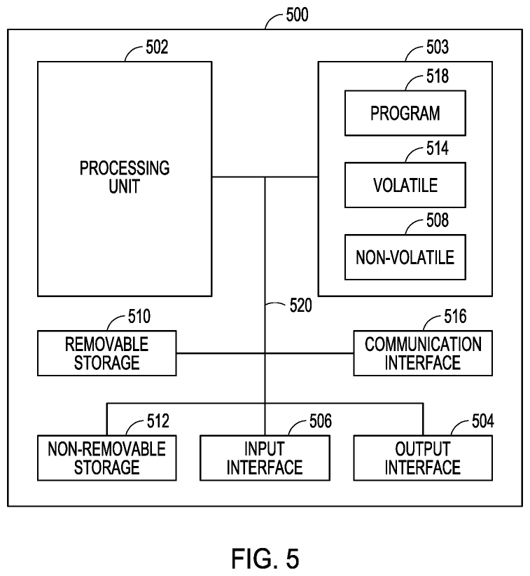

FIG. 5 is a block schematic diagram of a computer system 500 to implement devices, computers, and management systems and for performing methods and algorithms for web-based device registration according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### EXAMPLES

1. A method includes establishing a communication connection between an electronic device to a computer, connecting the computer via a web browser to a remote management system, detecting the electronic device, providing a user interface via the computer displaying an identification of the electronic device, receiving a registration request for the electronic device via the user interface, and registering the electronic device with the remote management system responsive to the registration request.

2. The method of example 1 wherein the communication connections comprises a universal serial bus (USB) cable and wherein the method further includes enabling USB debugging.

3. The method of any of examples 1-2 and further including accessing the electronic device via WebADB (Web Android® Debugging Bridge).

4. The method of any of examples 1-3 and further including enabling network connectivity on the electronic device and computer.

5. The method of example 4 and further including connecting the electronic device to a network to complete registration with the remote management system.

6. The method of any of examples 4-5 wherein the user interface includes a remote management system portal and further comprising displaying a status of the electronic device

7. The method of example 6 wherein the status is “online.”

8. The method of any of examples 1-7 and further including provisioning the electronic device via the remote management system following registration.

9. The method of any of examples 1-7 and further including accessing connection information in the electronic device and transferring the connection information to the remote management device.

10. The method of example 9 wherein the connection information includes security information to authorize registration of the electronic device.

11. The method of any of examples 1-10 wherein the method is performed on multiple additional devices to register the multiple devices with the remote management system.

12. A machine-readable storage device has instructions for execution by a processor of a machine to cause the processor to perform operations to perform any of examples 1-11.

13. A device includes a processor and a memory device coupled to the processor and having a program stored thereon for execution by the processor to perform operations to perform any of examples 1-11.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
establishing a communication connection between an electronic device to a computer;
connecting the computer via a web browser to a remote management system;
detecting the electronic device;
providing a user interface via the computer displaying an identification of the electronic device;
receiving a registration request for the electronic device via the user interface; and
registering the electronic device with the remote management system responsive to the registration request.

2. The method of claim 1 wherein the communication connection comprises a universal serial bus (USB) cable and wherein the method further comprises enabling USB debugging.

3. The method of claim 1 and further comprising accessing the electronic device via WebADB (Web Android® Debugging Bridge).

4. The method of claim 1 and further comprising enabling network connectivity on the electronic device and computer.

5. The method of claim 4 and further comprising connecting the electronic device to a network to complete registration with the remote management system.

6. The method of claim 4 wherein the user interface comprises a remote management system portal and further comprising displaying a status of the electronic device.

7. The method of claim 6 wherein the status is “online.”

8. The method of claim 1 and further comprising provisioning the electronic device via the remote management system following registration.

9. The method of claim 1 and further comprising:
accessing connection information in the electronic device; and
transferring the connection information to the remote management device.

10. The method of claim 9 wherein the connection information comprises security information to authorize registration of the electronic device.

11. The method of claim 1 wherein the method is performed on multiple additional devices to register the multiple devices with the remote management system.

12. A machine-readable storage device having instructions for execution by a processor of a machine to cause the processor to perform operations to perform a method, the operations comprising:
establishing a communication connection between an electronic device to a computer;
connecting the computer via a web browser to a remote management system;
detecting the electronic device;
providing a user interface via the computer displaying an identification of the electronic device;
receiving a registration request for the electronic device via the user interface; and
registering the electronic device with the remote management system responsive to the registration request.

13. The device of claim 12 wherein the communication connection comprises a universal serial bus (USB) cable and wherein the operations further comprise enabling USB debugging, the method further comprising accessing the electronic device via WebADB (Web Android® Debugging Bridge).

14. The device of claim 12 wherein the operations further comprise enabling network connectivity on the electronic device and computer and connecting the electronic device to a network to complete registration with the remote management system.

15. The device of claim 14 wherein the user interface comprises a remote management system portal and further comprising displaying a status of the electronic device.

16. The device of claim 12 and further comprising provisioning the electronic device via the remote management system following registration.

17. The device of claim 12 wherein the operations further comprise:
accessing connection information in the electronic device; and
transferring the connection information to the remote management device.

18. The device of claim 17 wherein the connection information comprises security information to authorize registration of the electronic device.

19. A device comprising:
a processor; and
a memory device coupled to the processor and having a program stored thereon for execution by the processor to perform operations comprising:
establishing a communication connection between an electronic device to a computer;
connecting the computer via a web browser to a remote management system;
detecting the electronic device;
providing a user interface via the computer displaying an identification of the electronic device;
receiving a registration request for the electronic device via the user interface; and
registering the electronic device with the remote management system responsive to the registration request.

20. The device of claim 12 wherein the communication connection comprises a universal serial bus (USB) cable and wherein the operations further comprise enabling USB debugging, the method further comprising:
accessing the electronic device via WebADB (Web Android® Debugging Bridge);
enabling network connectivity on the electronic device and computer;
connecting the electronic device to a network; and
provisioning the electronic device via the remote management system following registration.
